(19) United States
(12) Patent Application Publication
(10) Pub. No.: US 2003/0061257 A1
(43) Pub. Date: Mar. 27, 2003

(54) Multithreaded universal daemon for network data exchanges

(76) Inventor: Javier Cardona, Alameda, CA (US)

Correspondence Address: FAY KAPLUN & MARCIN, LLP, 15O BROADWAY, SUITE 702, NEW YORK, NY, 10038, US

(21) Appl. No.: 09/963,199

(22) Filed: Sep. 25, 2001

(51) Int. Cl. G06F 9/00; G06F 15/16; G06F 15/173; G06F 9/46

(52) U.S. Cl. 709/102; 709/202; 709/318; 709/223

(57) ABSTRACT

A system and method for a multithreaded universal daemon (MUD) is described. The MUD is generated from library functions common to all daemons, and is optimized for a specific type of data and protocol. The MUD includes a plurality of data sockets monitored by one of a plurality of tasks. The tasks connect the data socket to an appropriate application specific connection handler when data is received.

### BACKGROUND INFORMATION

Interconnected devices in a network must be able to transfer information between one another to maximize their usefulness. Information sent to and received from these devices should comply with certain conventions or protocols, so that both sender and recipient are able to communicate. Protocols are thus an important ingredient to data transfers between devices, because they are the rules that two or more networked devices (e.g., computers, switches, embedded devices etc.) must follow to exchange information.

One of the most common protocols, Transmission Control Protocol (“TCP”), is an Internet standard, connection-oriented, transport layer protocol that provides reliable data transmission. Another important protocol is the Internet Protocol (“IP”). The IP protocol is a standard software element that keeps track of the Internet addresses for different nodes, routes outgoing messages, and recognizes incoming messages. Many additional protocols also exist, such as User Datagram Protocol (“UDP”), which is a protocol analogous to TCP, suitable for managing data exchange between embedded devices because it is resource efficient. Proprietary protocols developed for specific applications are also available. Protocols are typically organized in layers, such as defined in OSI Standard 7498. TCP and UDP are transport layer protocols, conceptually placed above the IP protocol, which is a network layer protocol. Upper layer protocols are conceptually even higher, and include session layer protocols.

When a device is connected to a network, there must be a monitoring process taking place in the device to determine if any data is arriving from the network. When data is received, this process invokes the appropriate protocol to process the data. This process is commonly referred to as a Daemon. Daemons are agent programs that continuously operate, for example, on a server, and provide resources to client systems on the network. These background processes can handle a variety of tasks, including monitoring the network for incoming data.

Data transmitted over a network can have different forms, and can follow different protocols. For example, the data may be Telnet data in Command Line Interface (CLI) format, a web page in HTML format, or an Applet in Java format. Conventionally, a separate Daemon is required to process each different type of data. In a device that can expect to receive different data formats, different mechanisms for generating the appropriate Daemons must be provided, and different Daemons must be operating in the background when the device is connected to the network. Typically, the different daemons are created by different functions that are stored in the device's memory. The more daemons required by a network device, the more memory is used to store daemon related functions.

A network may include computer and non-computer devices capable of information transmission. Embedded devices are one example of non-computer devices that are capable of transmitting and receiving information via a network and servers. Embedded devices, or devices containing embedded code and elements to execute the code, are generally used to control or monitor processes, machinery, environments, equipment, communications and other functions or elements. Examples of embedded devices include personal digital assistants (PDA's) and mobile telephones.

### SUMMARY OF THE INVENTION

Embodiments of the present invention include a universal daemon of a networked device to manage data exchanges with a network. The daemon comprises a plurality of data sockets connected to the network and a plurality of tasks, at least one of the tasks being an active task monitoring the plurality of data sockets for reception of data.

In another aspect, the invention is a method of managing transfer of data from a network, comprising assigning a multithreaded universal daemon to a network port, generating sockets logically related to the port, spawning tasks adapted to monitor the sockets, and assigning one of the tasks to monitor sockets connected to the network for receipt of data. When data is received in one of the sockets, the method also includes activating from the one task an application specific connection handler, and transferring control of the socket receiving the data to the application specific connection handler for processing the data.

### BRIEF DESCRIPTION OF THE DRAWINGS

FIG. 1 is a flow chart showing exemplary steps for creating a multithreaded universal daemon according to the present invention;

FIG. 2 is a schematic diagram showing an exemplary embodiment of a multithreaded universal Daemon, according to the present invention;

FIG. 3 is a schematic diagram of a portion of a network using an exemplary daemon according to the present invention; and

FIG. 4 is a flow chart showing exemplary steps of the operation of the multithreaded universal Daemon, according to an embodiment of the present invention.

### DETAILED DESCRIPTION

The present invention can be further understood with reference to the following description of preferred exemplary embodiments and the related appended drawings, wherein like elements are provided with the same reference numerals. Embodiments of the present invention will be described in particular with reference to JAVA® applet servers, HTML servers, and Telnet servers. However, one skilled in the art will understand that the present invention may include different types of open or proprietary servers that can communicate using open or proprietary protocols, as well as different types of application level handler functions.

Embedded devices tend to have limited resources, such as reduced memory and computing speed. Accordingly, the duplication of processes such as the network communication daemons can severely test the limited resources available in embedded devices. Reductions in the number of processes that are required to perform a specific task, such as monitoring network traffic, can result in smaller, less expensive devices that require fewer resources. The daemon according to the exemplary embodiments of the present invention is well suited for use with embedded devices. However, the invention is not limited to use in such embedded devices.

It is generally necessary to provide to a networked device software elements that can process and monitor data exchanges with other devices on the network. These software elements are generally referred to as servers that execute background programs, or daemons, to carry out various functions. In the case of networked devices that have limited resources, such as embedded devices, the servers must be as compact as possible, with limited memory requirements and minimal duplication of code and run time processes. One of the principal tasks of the server is to monitor the network connections, and take appropriate action when data is received from the network.

A server may be functionally divided in two parts. A first part of the server monitors data and communication errors, maintains operating system resources such as memory, sockets and tasks, and handles task concurrence. A second part of the server implements the upper layer communication protocol itself. Generally, the first part is referred to as the daemon, the second part is the protocol handler, and the whole is referred to as the server. In the context of this application, the terms server and daemon may be used interchangeably. There are three common types of protocol handlers: Initialization handlers that are called when a connection is first established, data handlers that are called when data is available through the socket, and error handlers that are called when any communication or other error affecting the application occurs. The server may also include a set of instructions, for example contained in an instruction module, that direct the daemon to perform the tasks assigned to it.

To reduce the amount of resources required to create and operate a daemon, the common elements present in daemons that work with various types of data or protocols are isolated, and are incorporated in functions that a developer can execute to generate the daemon. These functions may be stored within a library of functions located in the device. The common elements are independent of the protocols and data encountered, and can be used to form the foundation of a universal daemon that may be adapted to work with any data or protocol. The functions that incorporate those elements can thus be used to create any required daemon, so that it is no longer necessary to store different functions dedicated to each daemon that may be needed by the device. Accordingly, the library where the functions are stored can be made considerably smaller.

Using this system the developer can create a daemon simply by executing the “create” library function, and by supplying the elements and variables that are specific to the type of daemon required. For example, to execute the library functions, the developer does not have to provide any input regarding the handling of sockets, the spawning of tasks and memory management. Those aspects are common to all daemons, and are handled automatically by the library functions. The developer may need to specify the various protocol-dependent aspects of the daemon, such as the handling functions that the daemon will invoke when data is encountered.

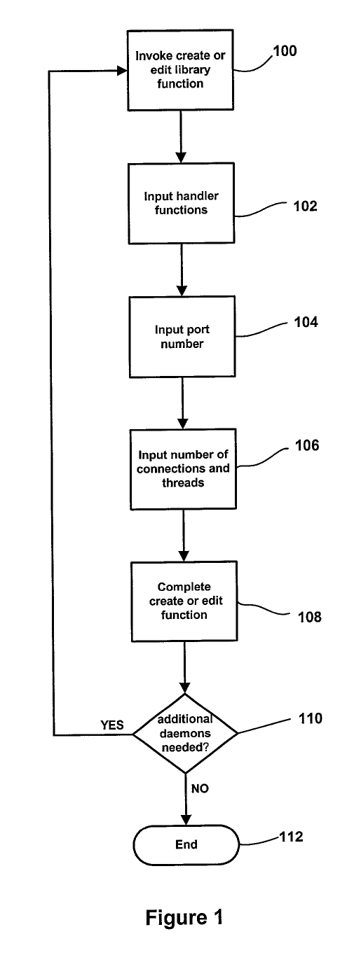

With reference to FIG. 1, an exemplary embodiment of the process to generate a daemon utilizing library functions according to the present invention is described. The library may be stored in a non-volatile memory of the device, for example Read Only Memory (ROM), disk or Flash memory. The library may contain functions that allow the developer to create a new daemon, or to edit an existing daemon. Since these functions are generic to all daemons, only one creating function and one type of editing function are required, minimizing code duplication. As a result, the amount of memory required to store the function library is reduced compared to systems where different functions are provided to generate daemons that process different protocols.

In one exemplary embodiment according to the present invention, the edit and create functions are separate, distinct functions. The create function is invoked only once, while the edit function may be used to alter the behavior of the daemon during runtime, after the daemon has been created. In this embodiment, only one create function is provided, that is used to create all daemons that may be required. However, multiple edit functions may be necessary, for use in different circumstances.

In step 100, shown in FIG. 1, the developer invokes a “create” library function to create a daemon. The library function, as described above, incorporates all the elements that are common to daemons processing data of all protocols, and is thus protocol-independent. The developer specifies parameters for the daemons to be created, including those parameters that are data or protocol specific. Alternatively, if the developer wants to modify an existing daemon, an “edit” library function can be invoked. Similarly to the “create” function, the “edit” functions do not have to be duplicated for different types of data and protocols.

Although the library functions incorporate the common parameters of the daemons, the developer may specify several parameters unique to the specific installation. For example, as indicated in step 102, the developer may specify the protocol specific functions that are called by the daemon when data is received from the network. In one exemplary embodiment, an initialization handler function may be specified. The initialization handler function handles the initial communication with the network when a connection is established. For example, an initialization handler function may send a welcoming message or a message identifying the device to the network.

Other handler functions may be specified by the developer for use by the daemon. One function may be a data handler, which is an application function that takes control and processes data received from the network. In one embodiment, the data handler is activated when data is received on a socket monitored by the daemon. At that point, the daemon calls up the data handler, specifies which socket has the data, and gives control of the socket to the data handler function. The developer may specify a data handler appropriate for the type of data and protocols associated with the port that the daemon will monitor. For example, port number 23 is conventionally used for Telnet applications. The developer would thus specify a daemon to monitor port number 23 that calls up a data handler function that can process Telnet data. Once the data handler has finished processing the data, control of the socket may be returned to the daemon, with instructions to keep the socket active or to close it. The data handler functions may be part of the application code that ultimately uses the network data, or independent code dedicated to data handling.

A third handler function may also be specified in step 102. For example, the developer may specify an error handling function to be called by the daemon when a problem occurs with the data reception. In one embodiment, when the daemon calls the error handling function during operation, it passes to the function an error code parameter describing the fault that has occurred, such as the socket table becoming full, the connection breaking, or some other problem. The error handler function then may return control of the socket to the daemon, with instructions to continue waiting for data or to close the socket. Additional functions to perform other data processing tasks may also be specified. It will also be apparent to one skilled in the art that not all the functions described above are necessary, and that some of the functions may be omitted.

In step 104 the developer may specify the port to which the daemon will listen. As is known in the art, under TCP certain ports are typically associated with certain types of connections. For example, according to TCP/IP convention, port number 23 is used for Telnet connections, port number 25 is used for Simple Mail Transfer Protocol (SMTP) connections, and port number 80 is used for Hyper Text Transfer Protocol (HTTP) connections. Accordingly, the developer assigns a port to a daemon that includes handler functions capable of processing the appropriate type of communication.

As will be explained in greater detail below, when the daemon is monitoring a port, it spawns a number of identical tasks that are used to transfer control of a data receiving socket to the appropriate application-specific connection handler. One of the parameters that may be specified when invoking the library's daemon creation function is the number of tasks to be spawned. This may be done in step 106. Also in step 106, or optionally in a separate step, the developer may specify how many concurrent connections can be processed simultaneously by the daemon.

In the context of this application, the terms thread and task are used interchangeably to indicate a part of a program that can execute independently of other parts of the program. In one embodiment according to the invention, the tasks spawned by the daemon may be infinite loops that carry out the following steps:

1. Wait for a lead token (First blocking point).

2. Prepare a list of connections to wait on.

3. Block (wait) on list of connections (Second blocking point).

4. Release lead token.

5. If unblocked due to an error, invoke error handler function.

6. Otherwise invoke data handler function.

7. Evaluate handler return value to determine if connection is to be closed.

8. Return to step one.

Blocking refers to a program step executed by each task to determine whether it should pause or continue execution of the program loop. If the task currently has the lead token, indicating that it is the current active task, it will continue or resume execution of the program steps. If the task does not have the lead token, it will pause, and another task having the lead token will instead continue execution. This scheme is necessary to ensure that multiple tasks never accept the same connection. If the protocol handlers cannot block a task, the task will block itself in one of the first or second blocking points, unless it has the token. The use of a lead token to determine which task is active ensures that only one task at a time blocks at the second blocking point, which is the point where the sockets are actually being monitored. The token system will be described in greater detail below.

The exemplary daemon according to the invention is multithreading, that is, it spawns multiple threads or tasks that exist concurrently. Thus, multiple tasks are available to take over monitoring the sockets when one task blocks. This may occur, for example, when a data handler reads a file or waits for user input. In this context, the sockets are artifacts of the operating system used to establish and maintain a communication through a TCP/IP connection, thus the terms socket and connection may be used interchangeably. The daemon internally labels the connections it monitors as IDLE, BUSY or CLOSED. IDLE connections are open connections that the daemon is monitoring. BUSY connections are open connections that the daemon does not monitor, because they are being used by the data handler. CLOSED connections are simply closed.

The developer may also specify how many concurrent connections may be supported by the daemon. Once a TCP/IP connection is established, the data flow through that connection is not homogeneous, but there may be periods of socket inactivity between data arrivals. The exemplary daemon according to the present invention supports concurrent connections because it does not bind its tasks to a particular socket, but any task can handle any one of the sockets. The number of simultaneous connections that the daemon can service is therefore independent of the number of tasks or threads, so that a single multi threaded daemon can service multiple connections. However, the maximum throughput that can be achieved per connection is inversely proportional to the number of concurrent connections existing at a given time.

In one exemplary embodiment, the developer may specify the parameters shown in the following list to be used by the library functions in generating the daemon, e.g., parameters specified as part of the “create” function. Some of these parameters are optional in this exemplary embodiment.

acceptIP, port: are the local address and port to which the daemon will be bound.

maxActiveCons: the maximum number of active connections supported.

timeOutinSecs: time after which an idle connection will report an error.

numOfThreads: number of allowed threads.

priority: priority at which the daemon will execute.

stackSize: stack size for each thread.

sizeOfPermMemPool: size of the daemon's managed single permanent memory pool, has the same life span as the daemon.

sizeOffempMemPool: size of each of the daemon's managed temporary memory pools. There are maxActiveCons temporary memory pools, having the same lifespan as the daemon, but they are cleared every time a connection is closed.

conHandler: this is used to access a desired protocol connection handler.

errorHandler: this is used to access a desired protocol error handler.

pNewMud: a return value, a pointer to the newly created daemon

In addition to the parameters described above for the functions that create a new daemon, additional parameters may be necessary when invoking a daemon editing function. The following additional parameters may be required in the exemplary embodiment:

mud: pointer to a valid MUD (multithreaded universal daemon). This identification parameter may be returned by the function that created the MUD in question.

initHandler: the optional protocol initialization handler that may be changed at runtime.

Once all the required and optional parameters that are protocol-dependent have been specified, execution of the library's protocol-independent “create” or “edit” functions may be completed in step 108. At this point, the generation of the daemon(s) for the communications server is carried out automatically. The resulting daemon is referred to as a multithreaded universal daemon (MUD), because it is capable of simultaneously monitoring many connections, up to the number that was specified as a parameter in the create function, and the same library functions are used to create and edit daemons that work with any type of data, using any protocol.

Step 110 indicates a decision point, where it is determined whether the process is to be repeated to generate another daemon that will monitor a different port, or whether the creation process is complete. If another port is to be monitored, the process returns to step 100, where the create or edit functions of the library are invoked, and the appropriate parameters are then provided for generation of a new daemon or are modified during runtime by means of the appropriate edit functions.

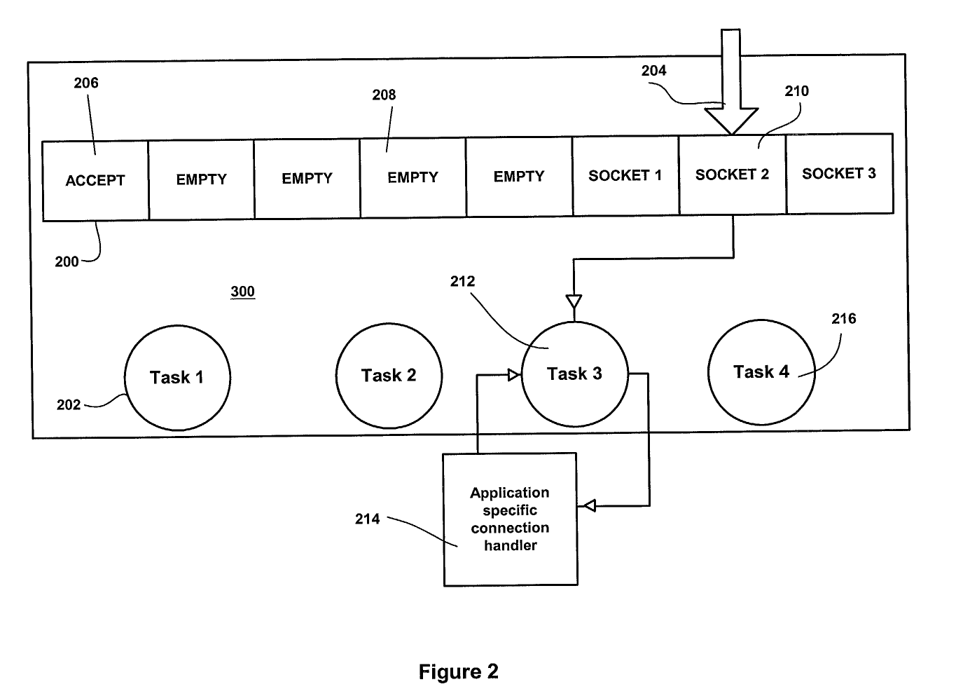

A description of an exemplary embodiment of a multi threaded daemon according to the present invention follows, with reference to FIG. 2. The daemon 300 is schematically represented as including an array of sockets 200 and a plurality of tasks 202. In this example, there are seven sockets being monitored, and an accept socket 206 through which the data is initially received. In this example there are four tasks, which will be described in more detail below. For example, as described above, the number of sockets and tasks may be specified in parameters used in the generation of the daemon.

FIG. 2 shows a snapshot of an exemplary state of the daemon 30, in which seven sockets are being monitored. In particular, the accept socket listens to the port specified by the user. Once a connection is established, the TCP protocol assigns a unique port to each socket and communicates it to the other end of the connection, in a process that is transparent to the Daemon. Three sockets are connected to the network in FIG. 2, and one socket (second socket 210) is receiving data. One task is active (third task 212) and the three other tasks are available to become active when needed.

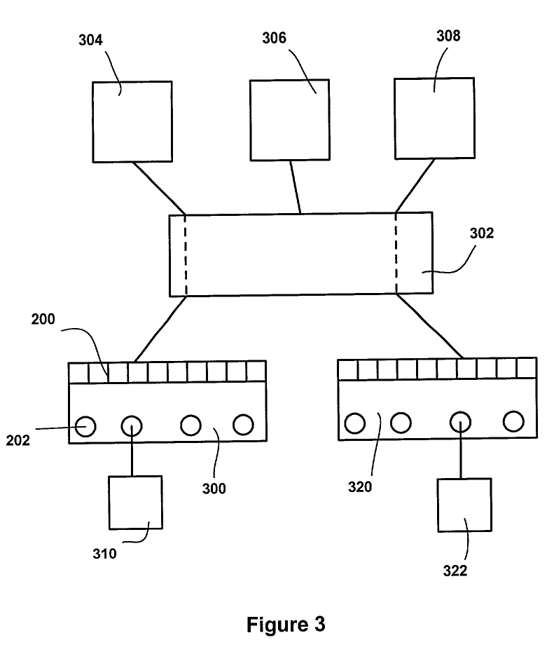

FIG. 3 shows an exemplary TCP/IP interface between applications on a networked device and the network. TCP/IP layer 302 exchanges data on the network side with, for example, a Telnet connection 304, an HTML connection 306, and a proprietary connection 308, which may be a JAVA Applet connection. On the device side, TCP/IP layer 302 sends and receives data from various applications, with the intermediary of daemons. In this example, a daemon 300 is assigned to a port carrying the Telnet connection, and another daemon 320 is assigned to a port carrying the proprietary connection. Both daemons are similar, and include a number of sockets 200 and tasks 202, as described above. However, daemon 300 is adapted to call up an application handler 310 that can process Telnet data, while daemon 320 calls an application handler 322 that can process the proprietary data. In general, there can be as many Daemon's as there are ports in the system.

Returning to FIG. 2, daemon 300 includes an accept socket 206 whose function is to receive a connection request from the TCP/IP layer 302 for network data. The daemon then assigns the connection to one of the available empty sockets, for example second socket 210. Daemon 300 also notifies a currently available task that second socket 210 must be monitored for data. In the example shown in FIG. 2, third task 212 is assigned to monitor second socket 210, as well as the first and third sockets which also have connections. When data 204 is received in second socket 210, third task 212 calls the appropriate application specific connection handler 214, which processes the data in accordance with the particular application.

In the exemplary embodiment shown in FIG. 2, the sockets 200 are shown in three states. The accept socket 206, as describes above, receives the connection requests from the network. Empty sockets 208 are available for connections, but a connection has not been assigned to them, so that they do not need to be monitored by the Daemon. The connected first, second and third sockets have been assigned connections, but do not necessarily have data reaching them. In the example, only second socket 210 is receiving data 204. All the connected sockets, however, must be monitored by the daemon 300.

The number of tasks 202 active within daemon 300 may be specified when the daemon is created. In this example, four tasks are active. In one embodiment, all the tasks are identical, and may consist of a loop that repeatedly monitors the sockets with connections for data. In this embodiment only one task at a time is active. For example, a token system may be used to determine which task is active at any given time. In the example show in FIG. 2, third task 212 has the token, and thus is monitoring the sockets. Once data 204 is received in second socket 210, or in any of the monitored sockets, the token is passed to the fourth task 216, that will begin to monitor the remaining connected first and third sockets.

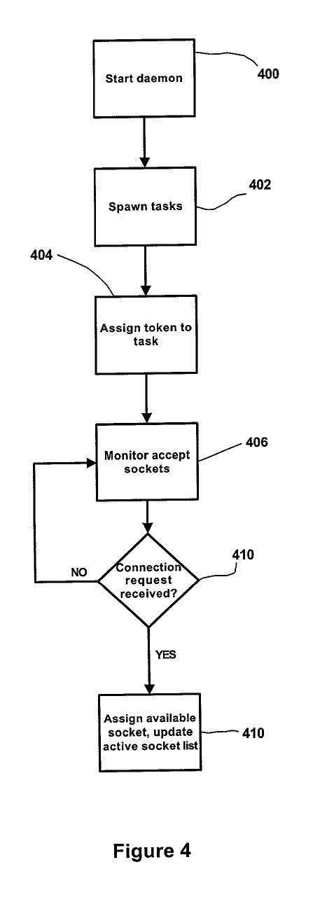

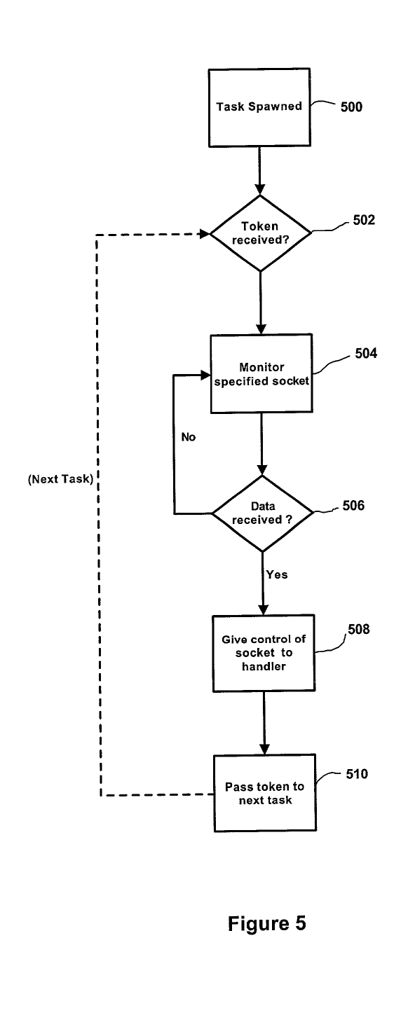

An exemplary sequence of operations undertaken by the daemon 300 is described with reference to FIG. 4. After being created, operation of the daemon 300 starts in step 400 as part of a server that handles network communications. As indicated above, the daemon 300 only monitors one port, and thus multiple daemons 300 are required to monitor additional ports. In step 402 the daemon spawns a number of tasks 202, which may all be identical. One of the tasks, for example the third task, is given the lead token in step 404, meaning that it is assigned as the active task that will monitor the connected sockets.

The tasks may be used sequentially in the daemon, so that when the current active task becomes busy directing a data thread to an application specific connection handler, the following task starts monitoring the remaining connected sockets. The daemon continues to monitor accept socket 206 in step 406, while the tasks 202 execute. If another connection request is received in step 408, the daemon assigns the connection to a previously empty socket in step 410, and notifies the active task to also monitor that socket. This may be done by updating a list of connected sockets to be monitored. If no connection request is received, daemon 300 continues to monitor the accept socket.

The operation of the tasks spawned is described with reference to FIG. 5. After being spawned in step 500, a task determines in step 502 if it has received the token. If it has received the token, the task becomes the active task, otherwise it continues to wait until the token is received. The active task monitors the specified connected sockets in step 504. The connected sockets are those to which the daemon has assigned a connection request received by the accept socket. If data is not received in any of the connected sockets, step 506 directs the task to continue monitoring the connected sockets. As soon as data is received, step 506 directs the task to step 508, where the data is turned over to the data handler. Specifically, the active task calls up the appropriate application specific connection handler, and turns over to it control of the socket with the data. The active task also passes to the subsequent task the token in step 510, thus making active the subsequent task. The subsequent active task is instructed to monitor the connected sockets, minus the socket just turned over to the application specific connection handler. The subsequent active task, for example the fourth task 216 shown in FIG. 2, returns to step 504 to continue monitoring the active sockets.

Once the application specific connection handler has terminated processing the data thread, it returns control of the socket to the daemon, with instructions to either resume monitoring that socket or to make it available for other connections. Depending on the instructions regarding the socket, in step 410 the daemon may update the list of active sockets being monitored by the subsequent active task, or may redefine the second socket 210 as an empty socket. The daemon may continue operating as long as the port to which it is associated is open. Once the port is closed, the daemon may be deactivated.

Although the invention has been described specifically with reference to a system where one or more daemons are used to monitor Telnet, HTML and proprietary data between a network and one device, any protocol operating on any network can be used with the server according to the invention. The specification and drawings are thus to be regarded as being illustrative rather than restrictive. It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A universal daemon of a networked device to manage data exchanges with a network, comprising:
a plurality of data sockets connected to the network; and
a plurality of tasks, at least one of the tasks being an active task monitoring the plurality of data sockets for reception of data.

2. The universal daemon according to claim 1, wherein the active task assigns an application connection handler function to one of the plurality of sockets that receives data, the handler function processing the data.

3. The universal daemon according to claim 1, further comprising an accept socket to receive requests for communications.

4. The universal daemon according to claim 1, wherein the application connection handler function is a protocol specific function specified during creation of the universal daemon.

5. The universal daemon according to claim 2, wherein the active task is adapted to be deactivated after assigning the application connection handler function, and another of the plurality of tasks is adapted to become active.

6. A method of managing transfer of data from a network, comprising:
generating sockets logically related to a network port;
spawning tasks adapted to monitor the sockets;
assigning one of the tasks to monitor sockets connected to the network for receipt of data;
when data is received in one of the sockets, activating from the one task an application specific connection handler; and
transferring control of the socket receiving the data to the application specific connection handler for processing the data.

7. The method according to claim 6, further comprising assigning an additional one of the tasks to monitor the sockets when the application specific connection handler is activated.

8. The method according to claim 6, further comprising updating a list of sockets to be monitored by the tasks.

9. The method according to claim 6, further comprising activating from the task an error handling function when a selected error occurs.

10. The method according to claim 6, further comprising activating from the task an initialization handler when data is initially received in the socket.

11. The method according to claim 6, wherein the method is performed by a daemon, and further comprising returning control of the socket receiving the data to the daemon when processing the data is completed.

12. The method according to claim 6, wherein the method is performed by a daemon, and wherein the daemon is generated from a protocol-independent library function and from protocol-dependent parameters.

13. The method according to claim 12, wherein the protocol-dependent parameters include a number of tasks to be spawned by the daemon an a number of sockets monitored by the daemon.

14. A method for creating a network server daemon, comprising:
selecting from a library protocol-independent functions;
specifying a protocol-dependent data handler to be used by the protocol-independent function;
specifying a number of simultaneous connections to be monitored by the daemon;
specifying a number of tasks to be spawned by the daemon to monitor the connections; and
executing the protocol-independent function to generate code defining the daemon.

15. The method according to claim 14, further comprising specifying at least one of a protocol-dependent initialization handler and error handler to be used by the protocol-independent function.

16. The method according to claim 14, further comprising selecting a protocol-independent edit function to modify the code defining the daemon.

17. A computer readable medium having stored thereon instructions adapted to be executed by a processor, wherein the instructions when executed initiate a method for managing data exchanges comprising:
retrieving from a library a protocol-independent function to generate a daemon;
retrieving from memory common parameters adapted to be used by the protocol-independent function;
receiving as inputs protocol specific parameters adapted to be used by the protocol-independent function; and
executing the function to generate a daemon including the common parameters and the specific parameters.

18. The medium according to claim 17, wherein the method further comprises receiving as inputs at least one of a number of sockets, a number of simultaneous connections to be monitored by the daemon, and a number of tasks to be spawned by the daemon.

19. A system for generating a network server daemon, comprising:
a library containing protocol-independent functions;
a protocol-dependent data handler to be used by the protocol-independent functions;
an input module to obtain a number of simultaneous connections to be monitored by the daemon; and
an input module to obtain a number of tasks to be spawned by the daemon to monitor the simultaneous connections; wherein
executing the protocol-independent functions generates code defining the daemon.

20. The system according to claim 19, further comprising at least one of a protocol-dependent initialization handler and error handler to be used by the protocol-independent functions.

21. The system according to claim 19, further comprising protocol-independent edit functions of the library adapted to modify the code when executed.
